(19) United States
(12) Patent Application Publication
(10) Pub. No.: US 2018/0310523 A1
(43) Pub. Date: Nov. 1, 2018

(54) Leg Sock for Horses

(71) Applicant: Raymond Petterson, Tallahassee, FL (US)

(72) Inventor: Raymond Petterson, Tallahassee, FL (US)

(21) Appl. No.: 15/832,461

(22) Filed: Dec. 5, 2017

Related U.S. Application Data
(63) Continuation-in-part of application No. 14/922,702, filed on Oct. 26, 2015, now abandoned.
Application No. 14/922,702 is a continuation-in-part of application No. 12/980,715, filed on Dec. 29, 2010, now abandoned.
Application No. 12/980,715 is a continuation-in-part of application No. 12/317,655, filed on Dec. 24, 2008, now abandoned.

(51) Int. Cl. A01K 13/00; B68C 5/00; D04B 1/22; D04B 21/20

(52) U.S. Cl. CPC A01K 13/007; B68C 5/00; D10B 2401/061; D04B 21/20; D04B 1/22

(57) ABSTRACT

The present invention comprises a sock for use on the leg of a horse or ungulate, such as a cow, donkey or other hoofed animal. In the preferred embodiment the sock is tubular in shape having an upper opening and a lower opening. The sock is generally comprised of an upper cuff, main body and lower cuff. The upper cuff and main body are configured to frictionally engage creating a circumferential force on the leg of the horse such that the sock will not easily slip down on the leg of the horse. Expanded knit around the fetlock joint allows for the free motion of the joint thus alleviating contrary forces that would normally and otherwise cause the sock to be pulled down by that motion. The lower cuff is configured to expand over said hoof of said ungulate.

### CROSS-REFERENCES TO RELATED APPLICATIONS

This non-provisional application is a continuation-in-part of U.S. patent application Ser. No. 14/922,702 (filed Oct. 26, 2015) which is a continuation-in-part of U.S. patent application Ser. No. 12/980,715 (filed Dec. 29, 2010) which is a continuation-in-part of U.S. patent application Ser. No. 12/317,655 (filed Dec. 24, 2008). The continuation-in-part applications list the same inventor.

### STATEMENT REGARDING FEDERALLY SPONSORED RESEARCH OR DEVELOPMENT

Not Applicable

### MICROFICHE APPENDIX

Not Applicable

### BACKGROUND OF THE INVENTION

### 1. Field of the Invention

This invention relates to the field of horse leggings. More specifically, the invention comprises a sock that fits over the leg of a horse for protection or temperature regulating purposes.

### 2. Description of the Related Art

Horses spend a great deal of time outside in both the winter and the summer months. Due to exposure of the legs of a horse to inclement weather, UV light, insects, and plants, a horse would benefit a great deal from a leg sock. Metabolically challenged horses often have difficulty adjusting to cold temperatures. This is a health hazard for horses that have experienced founder or chronic laminitis as blood vessels in their legs and hooves are likely already damaged. This damage can worsen in cold weather, causing extreme pain and even laminitis. Keeping a horse's legs warm by using leg socks can help to keep those blood vessels working at full capacity. Leg socks can improve the very quality of a circulation-impaired horse's life. Additionally, horses suffer from a number of different medical conditions related to their legs. A properly designed leg sock can offer some relief for leg conditions such as arthritis by keeping the legs insulated from cold temperatures. The act of insulating the leg can also benefit the horse by keeping its leg warm prior to racing, jumping, or other activities, thus reducing the risk of common leg injuries. A sock for summer wear can offer further relief, by warding off flies or by reflecting UV light. Flies cause horses to stomp their legs obsessively leading to cracks and splits in the wall of the hoof as well as the loss of shoes resulting in lameness or weakened hoof integrity. Additionally, flies often bite legs raw, causing infections and stopping the healing processes of wounds and injuries. Exposure to UV light exacerbates infections or dermatological diseases a horse has already suffered. Thus, a sock which offers cooling properties is desirable as well.

Horses often develop cellulitis, lymphangitis or lymphedema due to injuries. Horses tend to scratch the infected areas because of itchiness or pain. The scratching will worsen the infection or make the healing progress slower. A properly designed leg sock can cover damaged skin area to help a horse heal from these infections or dermatologic diseases.

Previously, leg socks, braces, or wraps contained loops, snaps, zippers, straps, or other means of securing the device in place on the horse's leg. These attachment means can cause problems for the horse, such as if the horse gets caught in a pasture hazard because of the attachment device or if the horse handler puts the device on incorrectly causing improper constriction resulting in bowed tendons or impaired circulation. This can be detrimental to the horse's health. Additionally, prior art leg socks do not stay well on the leg of the horse because they either roll up or slip down during movements.

Therefore it is desirable to create a sock that is easy to take on and off, which will remain secure on the horse's leg while the horse moves around and which will properly regulate temperature. The present invention achieves this objective, as well as others that are explained in the following description.

### BRIEF SUMMARY OF THE INVENTION

The present invention comprises a sock for use on the leg of a horse or other hoofed ungulates, such as a cow, mule or a donkey. In the preferred embodiment the sock is tubular in shape having an upper opening and a lower opening. The sock is generally comprised of an upper cuff, main body, and lower cuff. The upper cuff, main body and lower cuff are configured to frictionally engage the leg of the horse such that the sock will not easily slip down on the leg of the horse. The main body of sock is configured to expand specifically at the fetlock joint allowing for unimpaired motion at the joint. The expansion of the knit in main body around this joint reduces forces on the sock created by the movement of the joints, which would otherwise cause the sock to be pulled down. The main body of sock also covers and conforms to the smaller shape of the pastern, preventing the sock from slipping back down over the back of the hoof. A lower cuff is configured to cover the coronet band, providing protection from flies.

### BRIEF DESCRIPTION OF THE SEVERAL VIEWS OF THE DRAWINGS

FIG. 1 is a perspective view, showing one embodiment of the present invention.

FIG. 2 is a perspective view, showing one embodiment of the present invention on the leg of a horse.

FIG. 3 is a perspective view, showing one embodiment of the present invention over a hoof of a horse.

FIG. 4 is a perspective view, showing one embodiment of the present invention being put on a horse.

FIG. 5a is a perspective view, showing a user taking one embodiment of the present invention off of a horse.

FIG. 5b is a perspective view, showing a user taking one embodiment of the present invention off of a horse.

FIG. 5c is a perspective view, showing a user taking one embodiment of the present invention off of a horse.

FIG. 6 is a perspective view, showing the bottom cuff of the present invention.

FIG. 7 is a perspective view, showing one embodiment of the present invention.

FIG. 8 is a perspective view, showing another embodiment of the present invention.

FIG. 9 is a perspective view, showing the bottom cuff of another embodiment of the present invention.

FIG. 10 is a perspective view, showing another embodiment of the present invention.

FIG. 11 is a perspective view, showing another embodiment of the present invention.

FIG. 12 is a perspective view, showing one embodiment of the sock on the bent leg of a horse, showing forces acting on the sock as the leg bends.

FIG. 13 is a perspective view, showing another embodiment of the sock on the bent leg of a horse, showing forces acting on the sock as the leg bends.

FIG. 14 is a cross-sectional view, showing another embodiment of the present invention.

### REFERENCE NUMERALS IN THE DRAWINGS

10 sock
12 sock
14 upper cuff
16 main body
18 lower cuff
20 horse
22 foreleg
24 hind leg
26 hoof
28 handler
30 alternate upper cuff
32 alternate lower cuff
34 knee joint
36 toe
38 walls
40 heel
42 pastern joint
44 coronet band
46 upper opening
48 lower opening
50 fetlock joint
52 hock
54 first section
56 second section
58 third section
60 front leg
62 cannon
64 alternate main body
66 foot
68 outer layer of upper cuff
70 inner layer of upper cuff
12 outer layer of main body
74 inner layer of main body
76 first end of outer layer of main body
78 first end of inner layer of main body
80 second end of outer layer of main body
82 second end of inner layer of main body
84 seams over inner and outer layers of main body

### DETAILED DESCRIPTION OF THE INVENTION

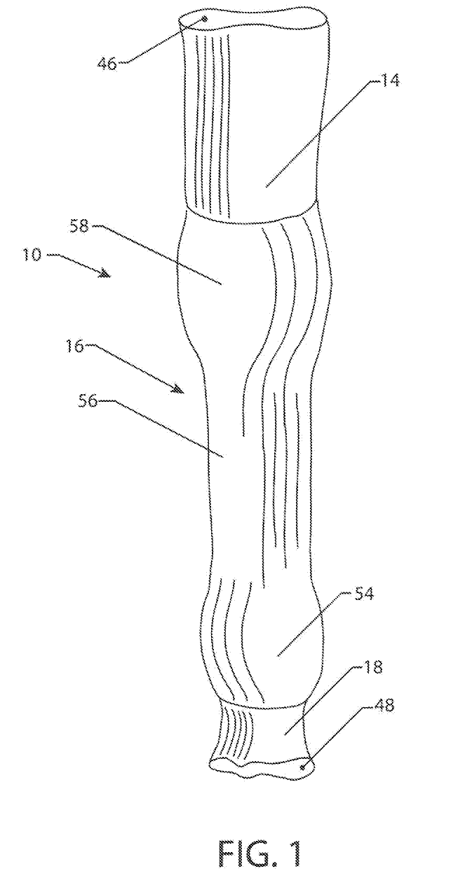

FIG. 1 illustrates one embodiment of present sock 10. The sock 10 is generally comprised of upper cuff 14, main body 16, and lower cuff 18. The sock 10 is tubular in shape having a hollow center containing upper opening 46 at the top of sock 10 and lower opening 48 at the bottom of sock 10. Lower cuff 18 is located at the bottom of main body 16 and is bell-shaped. Lower cuff 18 is knitted allowing lower cuff 18 to easily expand and contract. Main body is a more compact knit than the lower cuff knit. Upper cuff 18 is a more compact knit than the main body 16 knit.

As shown in FIG. 1, main body 16 is, in one embodiment, further comprised of first section 54, second section 56 and third section 58. First section 54 of main body 16 begins just above lower cuff 18, third section 58 begins just below top cuff 14 of sock 10 and second section 56 sits between first section 54 and third section 58. First section 54 and third section 58 allow for greater expansion than second section 56.

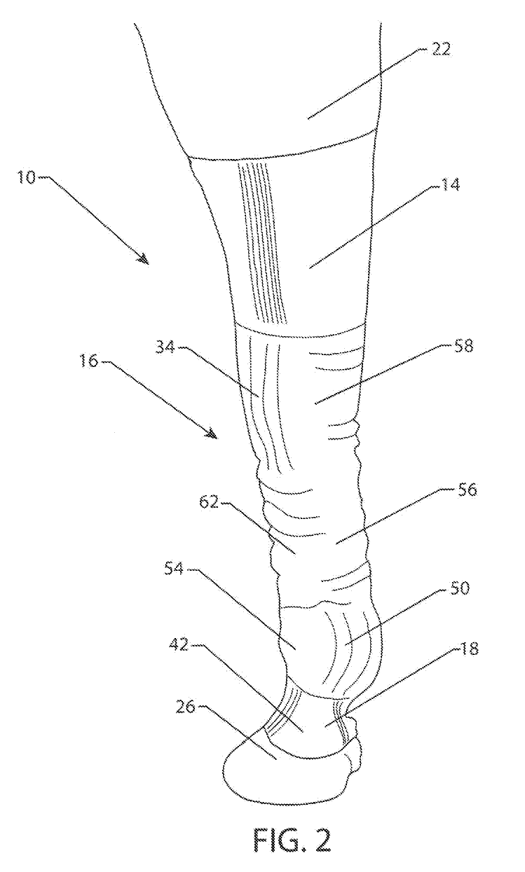

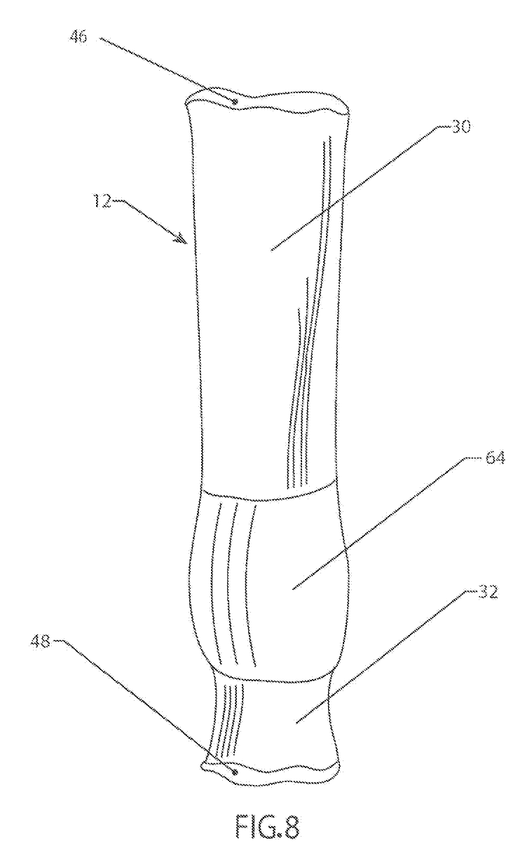

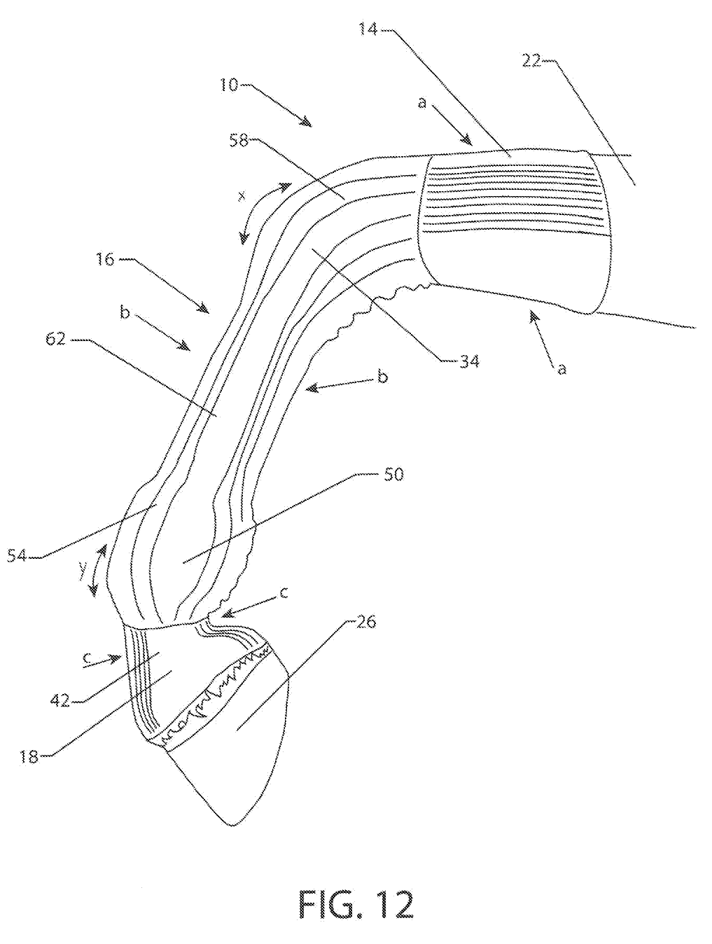

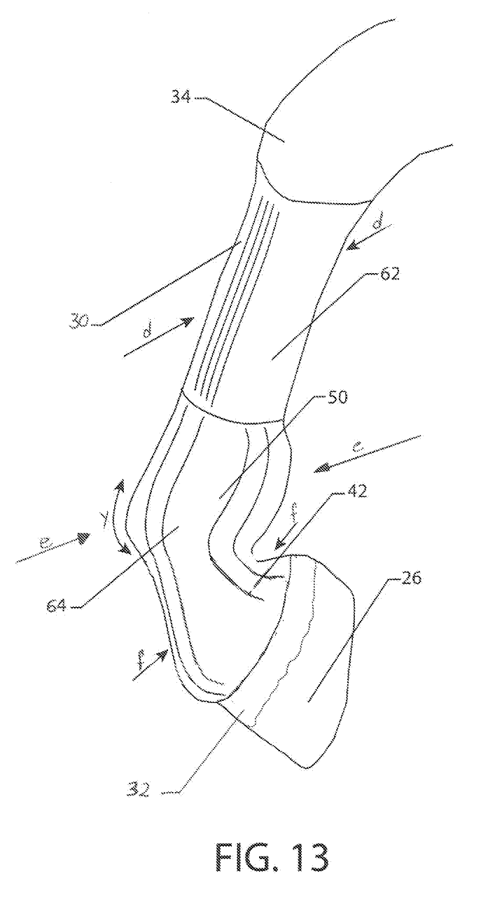

Sock 10 is shown on a horse leg in FIG. 2. Upper cuff 14 sits above knee joint 34 in one embodiment. Main body 16 extends from the bottom of top cuff 14, covering the knee joint 34, cannon 60 and fetlock joint 50, to the top of lower cuff 18. As described above, main body 16 is comprised of three sections 54, 56 and 58 in the presently described embodiment. Third section 58 of main body 16 sits just below top cuff 14 of sock 10. Third section 58 expands around the knee joint 34 in one embodiment reducing the force on the sock created by the motion of knee joint 34 (further described in FIGS. 12 and 13). First section 54, just above lower cuff 18, expands around fetlock joint 50 and pastern 42 thereby reducing any force on sock 10 created by the motion of this joint. The expansion and reduction of force on sock 10 assists in keeping sock 10 from slipping down on cannon 60. Second section 56 expands less than first section 54 and third section 58, conforming to cannon 60 and frictionally engaging cannon 60 of horse's leg. Main body 16 of the sock 10 has a length which is greater than the total length of the cannon 60 to permit further motion in the leg without causing sock 10 to slip down cannon 60. Additionally, the added length of sock 10 in main body 16 provides the benefit of more insulation for warmth. Lower cuff 18, located directly below main body 16, expands over hoof 26 and fits comfortably on pastern 42 above hoof 26 in this embodiment. The reader will note that the lower cuff in the preferred embodiment (FIGS. 8-11, 13, described) is a loose knit bell shaped portions that covers the coronet band (rather than conforming to pastern).

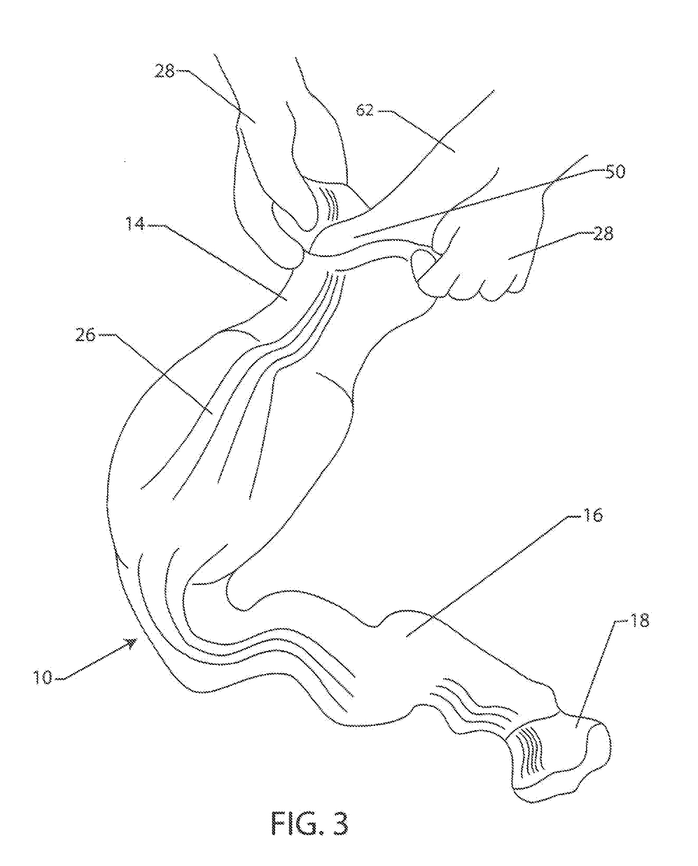

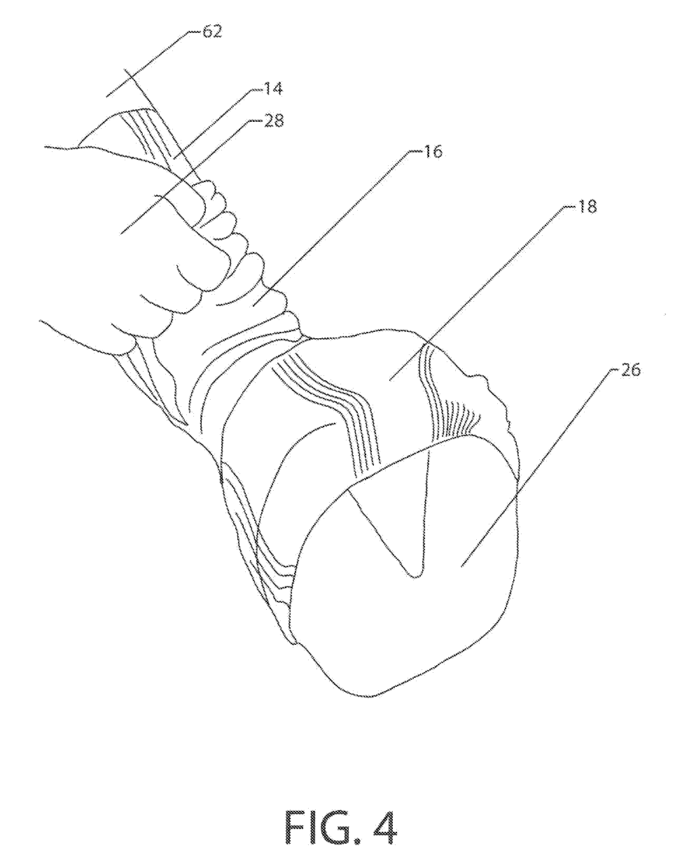

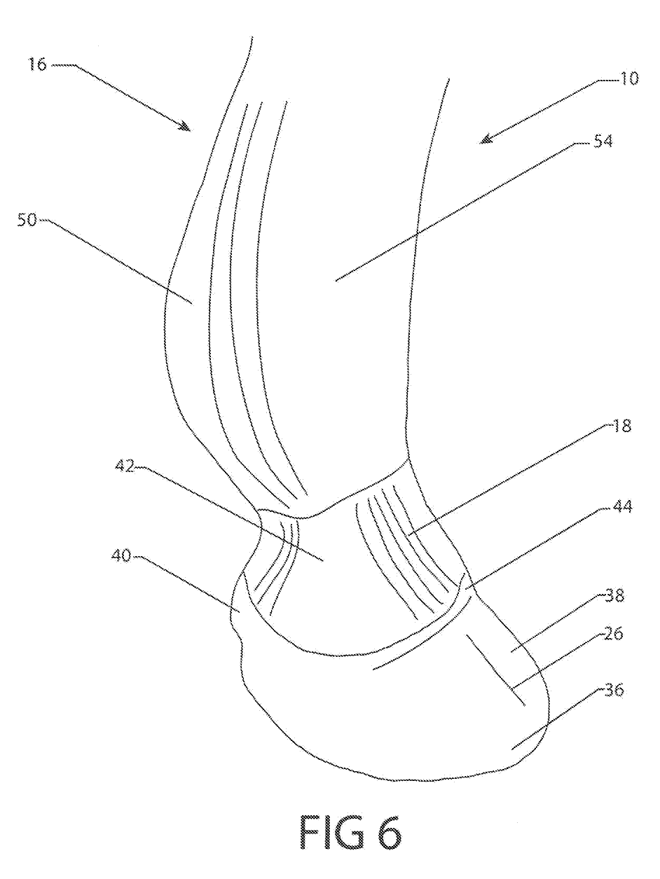

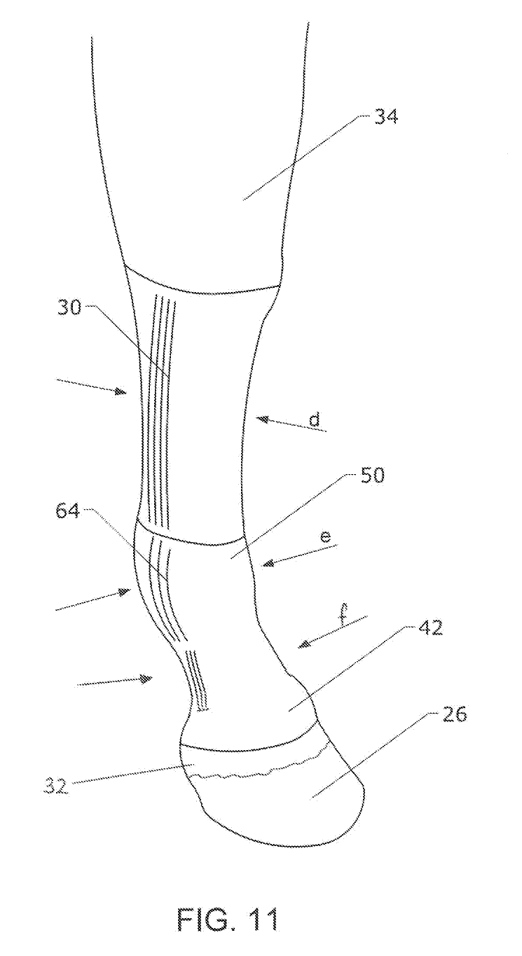

In FIG. 3 the reader can see how sock 10 is placed onto the leg of the horse. The horse's handler gently lifts cannon 62 and hoof 26 off of the ground and slips upper cuff 14 followed by main body 16 over the horse's hoof 26. As illustrated in FIG. 4, lower cuff 18 easily stretches over hoof 26 as handler 28 pulls upward on the sock. However, once lower cuff 18 passes over the hoof 26 it contracts again to securely fit pastern 42, as shown in FIGS. 2 and 6. Once the sock 10 is on the horse's leg it can be easily adjusted to ensure the correct placement (shown in FIGS. 2 and 11). The absence of an attachment means, such as Velcro, snaps, loops, or ties, eliminates the risk of handler 28 applying the present sock 10 in a manner that could injure the horse by wrapping or applying the attachment means in a way that causes improper vascular constriction or tendon constriction. Additionally, the absence of an attachment means reduces the risk of injury if the sock becomes tangled in a potential pasture hazard, such as fencing debris, thereby otherwise causing damage to the horse's leg. The present sock 10 is designed to slip off leg 22 if the sock 10 gets caught up in any significant external hazard.

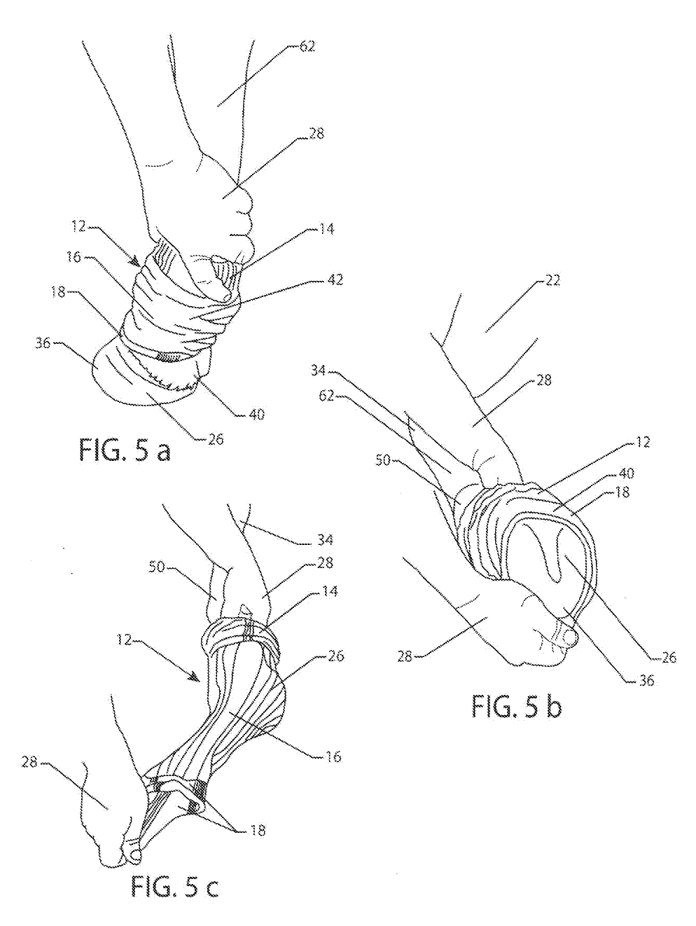

FIG. 5 a-c shows the manner in which handler 28 removes sock 10 from the horse's leg 22. While one embodiment of sock 10 is shown, the manner of removing the other embodiment of sock 12 (shown in FIG. 11) is identical in nature. First, as shown in FIG. 5a handler 28 pushes sock 10 down on horse's cannon 62 towards hoof 26. Sock 10 bunches together considerably in the present embodiment, naturally expanding as sock 10 is pressed downward. Next, as shown in FIG. 5b handler 28 gently lifts hoof 26 off of the ground grasping sock 10 at its base approximate to lower cuff 18 and pulling sock 10 over hoof 26. As handler 28 pulls sock 10 lower cuff 18, main body 16 and eventually upper cuff 14 slip off of the horse's leg with ease, as illustrated in FIG. 5c.

FIG. 6 illustrates lower cuff 18 and its location on the horse's pastern 42. As illustrated, a horse's hoof 26 contains toe 36 and heel 40, coronet band 44, and walls 38. Lower cuff 18 covers pastern 42 and ends just above coronet band 44. Lower cuff 18 acts to prevent main body 16 from slipping over walls 38, toe 36, and heel 40.

FIG. 2 shows upper cuff 14 located just above the knee joint 34. Since upper cuff 14 has a denser knit and greater level of elasticity than the body of sock 10, and because the knit is expanded around the knee joint 34 and fetlock joint 50, allowing free motion of the sock around those joints, sock 10 stays in place for extended periods of time. This is due to the fact that the forces created by the frictional engagement of the sock with foreleg 22, cannon 62 and pastern 42 are greater than the forces acting on sock 10, including those created by the motion of the joints and gravity itself. As illustrated in FIG. 6, lower cuff 18 is located in the reduced diameter of the pastern 42. Lower cuff 18 would have to expand to move up onto the fetlock joint 50 or down onto the hoof 26. Thus lower cuff 18 contributes to hold the sock in place. Again, the expansion of first section 54 of main body 16 over fetlock joint 50 joint permits the sock 10 to easily move with fetlock joint 50 as the horse moves, greatly assisting with keeping sock 10 in place.

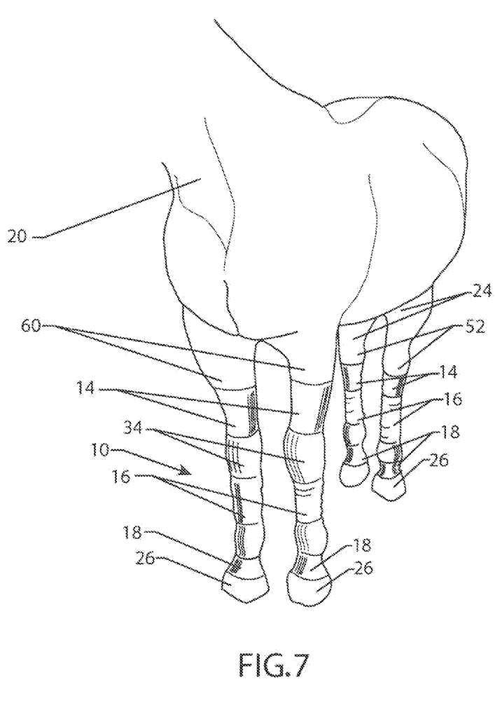

One embodiment of sock 10 is shown in FIG. 7 on both front legs 60 and hind legs 24 of the horse 20. On front legs 60, upper cuffs 14 of socks 10 are pulled above knee joint 34. However, on the horse's hind legs 24, upper cuffs 14 sit just below the horse's hocks 52. As shown, a large proportion of the horse's four legs are covered by the present socks 10. This benefits the horse by keeping the legs warm in the winter or before or after strenuous activity and by protecting the legs from insects and minor scratches from branches or brush.

Sock 10 is knitted from a yarn that has the ability to insulate the horse's leg, and frictionally engage the horse's leg while avoiding constriction of the leg or compromising circulation in any manner. One example of a yarn containing these properties would be a yarn containing, cotton, acrylic, wool, polyester, nylon, elastand (spandex), nylon Lycra and/or elastic hydrocarbon polymer (rubber). In the preferred embodiment the fibers contain FOSSHIELD® fiber technology (as discussed below). Main body 16 of the present sock 10 can be knitted using various sizes and density of cable knit stitch, in which the order of the stitches is permuted, to utilize as much yarn as necessary in order to create optimum insulation, protection and strength. Knit density, cross stretch, and levels of elasticity are changed through out the sock knitting process to provide optimum fit, “stay put” qualities and insulation for warmth and protection. By controlling the number of ends of yarns, the density of the stitch, the number of ends of elastic yarns, the tension or lack of tension of the yarn feeds, the plaiting of the yarns in concert with each other and the dimensional sizes of the various yarns, the present sock 10 expands as needed to be put on or taken off, while frictionally engaging with the leg to offer “stay put” qualities and optimum fit, warmth and protection.

The preferred embodiment of the present invention is shown in FIG. 8. In this embodiment, sock 12 is comprised of upper cuff 30, main body 64 and lower cuff 32. The upper cuff, main body and lower cuff each has a diameter in its relaxed state—a state which no external forces are asserted on it and there is neither compression nor tension in it. The upper cuff, main body and lower cuff each can be expanded to at least two times diameter of its relaxed state.

When the sock is expanded it exerts a circumferential inward compressive force on the object forcing the expansion as the sock attempts to return to its relaxed state. For purposes of this disclosure, the circumferential inward force is referred to as the compressive force or compressive pressure throughout. To determine the compressive force, a cylindrical object of varying diameters can be used to expand the sock at different points along the sock. The force exerted on the cylindrical object is measured, indicating the strength of continuous inward force on the object caused by both the knit and material make-up of the sock. The cylindrical object used to test the sock represents the hypothetical shape (although not necessarily the size) of a horse's leg. The compressive forces are important to the functionality of the sock itself. Specifically, the forces allow the sock to remain engaged with the leg of the horse without overly restricting it.

The compressive force asserted by the upper cuff when it is expanded to 1.5 times diameter of its relaxed state is configured to be in the range from 13 mmHg to 24 mmHg (but most preferably in the range from 15 mmHg to 22 mmHg). The compressive force asserted by the upper cuff when it is expanded to two times diameter of its relaxed state is configured to be in the range of 15-25 mmHg (but most preferably in the range from 18 mmHg to 24 mmHg). The compressive force asserted by the main body (at arrows labeled e in FIGS. 11 and 13) when it is expanded to 1.5 times diameter of its relaxed state is configured to be in the range of 10-17 mmHg (most preferably in the range from 12 mmHg to 15 mmHg). The compressive force asserted by the main body (at arrows labeled e in FIGS. 11 and 13) when it is expanded to two times diameter of its relaxed state is configured to be in the range of 15-22 mmHg (most preferably in the range from 17 mmHg to 20 mmHg). Finally, the compressive force asserted by the main body (at arrows labeled f in FIGS. 11 and 13) when it is expanded to 1.5 times diameter of its relaxed state is configured to be in the range of 9-15 mmHg (most preferably in the range from 11 mmHg to 13 mmHg). When expanded to 2.0 times the diameter of its relaxed state the compressive force asserted by the main body (at arrows labeled f) is configured to be in the range of 14-20 mmHg (most preferably in the range from 14 mmHg to 20 mmHg).

The reader will appreciate that the range of compressive force accounts for various factors that affect the sock. For example, each welt (upper cuff, and main body primarily) is not completely uniform in size across the welt. Thus, there is a slight variation in the resting diameter of the main body, for example, which would cause the compressive pressure to be slightly varied. Additionally, the sock can stretch over time, thereby reducing the amount of compressive force exerted on the leg when in use. Other factors include, but are not limited to, the ambient temperature around the sock and absorption of moisture of the sock. The size of the legs of a horse also affects the compressive pressure—however, the testing was designed to control for the size of the leg, as the leg itself is not claimed.

Table 1 on the following page shows the average compressive pressure measured at different points on three different sock sizes, based on the breed of the horse. The embodiment tested and claimed is shown in FIGS. 8-11 and 13-14. Each size maintains the same or approximately the same scale ratio in relation to one another. Therefore, while the sizes differ they are simply scaled down or up depending on the size of the horse. Because of this the range of compressive pressure is the same. Maintaining the optimum range of compressive pressure allows the sock to function effectively. As shown, the average tested compressive pressure in a relaxed state is 0 mmHg. In each instance, the pressure is measured at the upper cuff, main body at approximately the area of sock where the fetlock joint would be positioned and the main body at approximately the area of the sock where the pastern is positioned. The average compressive pressure was compiled based on a sampling of socks of each size. The average compressive pressure of each sock is shown at each point along the respective sock where each section is expanded to 1.5 times its diameter in a relaxed state and 2 times its diameter in a relaxed state.

TABLE 1
Average Compressive Pressure Measured at Different Points in Three Sizes of Socks

| | | | Average Compressive | Average Compressive |
|---|---|---|---|---|
| | | Compressive pressure | pressure at 1.5 times | pressure at 2 times |
| | | at relaxed state | diameter of relaxed state | diameter of relaxed state |
| | | (mmHg) | (mmHg) | (mmHg) |
| Socks for | Upper cuff | 0 | 21.9 | 22.3 |
| Sport/Pony | Main body at | 0 | 14.4 | 19.3 |
| | fetlock joint | | | |
| | Main body at | 0 | 12.5 | 17.2 |
| | pastern | | | |
| | Lower cuff | 0 | N/A | N/A |
| Socks for | Upper cuff | 0 | 18.3 | 21.4 |
| Quarter/Standard | Main body at | 0 | 13.8 | 20.6 |
| | fetlock joint | | | |
| | Main body at | 0 | 13.5 | 19.8 |
| | pastern | | | |
| | Lower cuff | 0 | N/A | N/A |
| Socks for | Upper cuff | 0 | 15.6 | 18.1 |
| Warmblood or | Main body at | 0 | 12.5 | 17.2 |
| Throughbred | fetlock joint | | | |
| | Main body at | 0 | 11.8 | 14.4 |
| | pastern | | | |
| | Lower cuff | 0 | N/A | N/A |

Sock 12 is illustrated in FIG. 11 on the leg of a horse. Upper cuff 30 conforms to the shape of cannon 62 and is held in place by a circumferential frictional engagement (including the compressive pressure exerted upon the leg). Upper cuff 30 applies biaxial compression to the leg of the horse and sits just below knee joint 34. Main body 64 is comprised of one expanded portion which expands around fetlock joint 50 and conforms to pastern and allows sock 12 to move freely with the movement of fetlock joint 50. The motion encouraging properties of alternate main body 64 prevent sock 12 from being pulled down on the leg of the horse every time the leg bends. In the present embodiment, lower cuff 32 offers negligible (or zero) compression and covers a portion of the hoof 26 (preferably proximate the coronet band 44). The lower cuff 32 should not extend too far such that it would interfere with the gait of the horse.

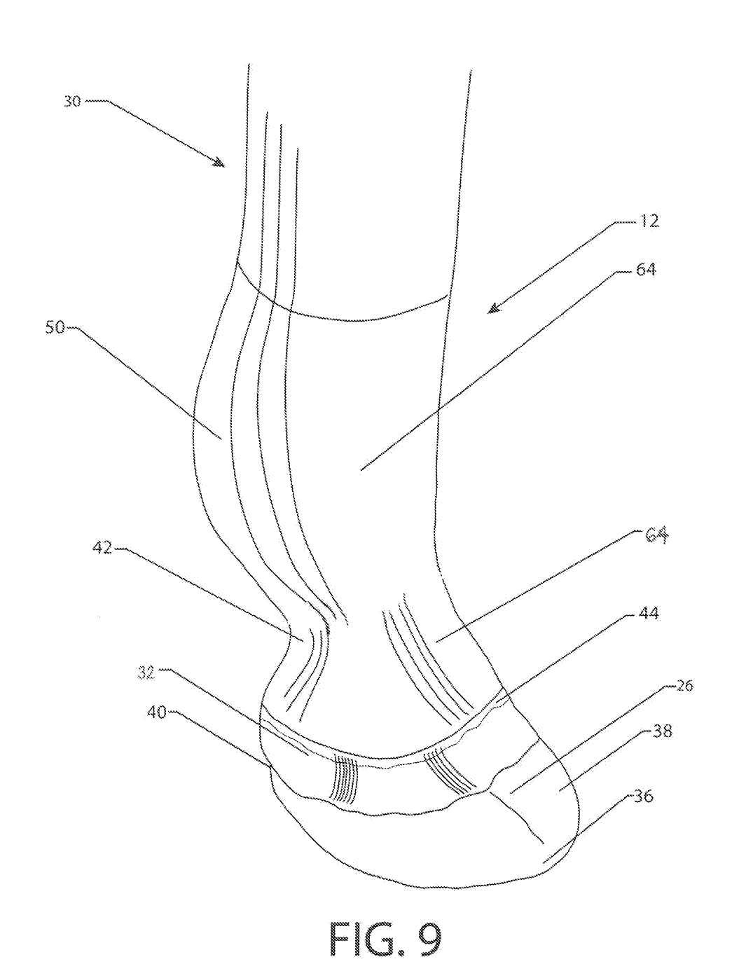

As shown in FIG. 9, main body 64 expands easily and fits comfortably over small pastern 42 without causing unnecessary constriction. Main body 64 comes to a rest just above coronet band 44 (while coronet band 44 would not normally be visible through sock 12 it is shown here for purposes of illustrating the location of the sock on the horse's leg). In a preferred embodiment, the lower cuff 32 can be in the form of a flat knit, loose fitting, bell shaped covering to add protection from flies to the coronet band 44. In such embodiment, the lower cuff 12 is designed to have zero or nearly zero compressive force on the hoof and pastern so the lower cuff will not roll up during the motion of the legs.

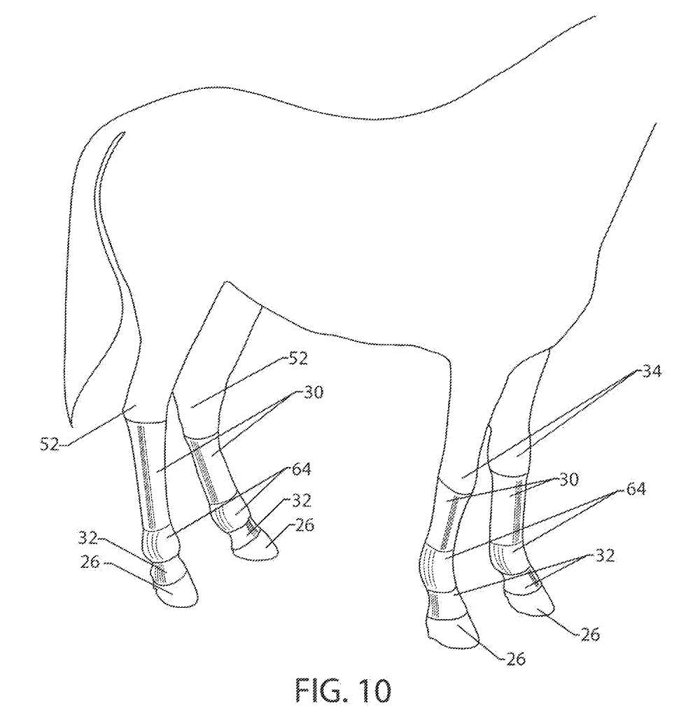

FIG. 10 illustrates the placement of the embodiment of socks 12 at the knees 34 and hocks 52 of horse 20. Socks 12 are held in place by frictional engagement (including compressive pressure) and kept in place by the properties of expansion built into main body 64 of sock 12. It is important that no straps, buttons, snaps, loops or Velcro are used to attach or constrict the socks 12 to the horse's legs. FIG. 11 illustrates the compressive force applied to a horse's leg by this embodiment of the sock. The reader will appreciate that the compression is circumferential (meaning that it is providing inward force at all points around the sock). For purposes of depicting the force, two arrows are shown. The upper cuff 30 provides a first amount of compressive force (shown as d) on the leg of the horse that is greater than a second amount of compressive force (shown as e) on the leg of the horse that is provided by main body 64 at or around the fetlock joint (when measured at points of equal circumference and at the relevant points of coverage of the leg of a horse). Therefore, sock 12 is held in place solely by frictional engagement caused by the compression of sock. An additional third amount of compressive force (shown as f) on the leg of the horse is provided by main body 64 at or around the pastern. The third amount of compressive force (f) is less than the first amount of compressive force (d).

The present sock 12 is shown in FIG. 10 on both front legs and hind legs of the horse. On front legs and hind legs, upper cuffs of socks are positioned just below the knee joint 34. As shown, a large proportion of the horse's legs are covered by the present socks. This benefits the horse by keeping the legs covered in the winter or before or after strenuous activity and by protecting the legs from insects and minor scratches from branches or brush and by promoting healing of dermatological diseases in the fending off harmful UV lights and covering infection areas.

Additionally, this embodiment can be knitted from various materials. One approach is to use a silver embedded fiber combined with a moisture managing fiber to make the yarns which make up the sock. The use of a silver embedded fiber combined with a moisture managing fiber allows for a clean environment around the leg of the horse. A yarn can also be treated with a FOSSHIELD® fiber treatment in which the fibrous material, or yarn, is embedded with silver and copper ions. Foss Manufacturing Company, LLC, of Hampton, N.H. developed FOSSHIELD® fabric technology which safely and naturally inhibits the growth of destructive and odor-causing bacteria, fungi, and mold, in the socks.

The present embodiment of sock 12 is preferably knitted from a yarn that has the ability to wick moisture from the horse's leg thereby keeping the leg cool. An example of a yarn containing these properties would be a yarn comprised of a blend of polyester, elastand (spandex), elastic hydrocarbon polymer (rubber) and treated with FOSSHIELD® fiber technology (as discussed above). In a preferred embodiment, the upper cuff 12 and main body 64 should use a yarn containing two ends of elastic hydrocarbon polymer (rubber) with a plurality of other fibers to achieve higher compressive forces while the lower cuff 32 should only use Lycra to achieve minimal compressive force.

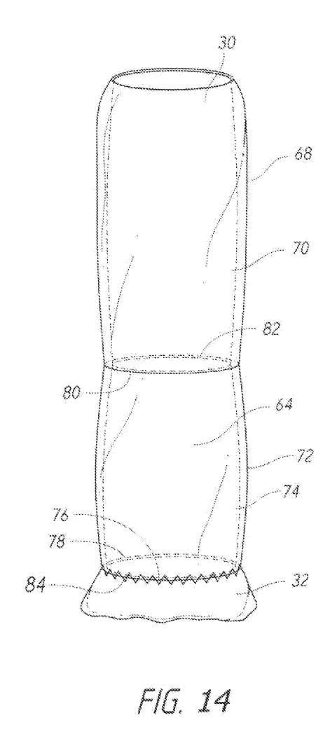

FIG. 14 shows a preferred embodiment of sock 12. Upper cuff 30 and the main body 64 are double layer structures (also called “welts”) while the lower cuff 32 is of a single layer structure. A welt structure offers additional warmth in the winter. The other benefit of a welt structure is that the frictional force between the two layers prevents the socks from rolling up or down which could happen during the movements of the legs. One process of making this embodiment is: knit the inner layer 74 of the main body 64, then the inner layer 70 of the upper cuff 30, then the outer layer 68 of the upper cuff 30, then the outer layer 72 of the main body 64, then fold the outer layer 72 of main body 64 and the outer layer 68 of the upper cuff 30 over the inner layer 74 of the main body 64 and inner layer 70 of the upper cuff 30, then sew over the first end 78 of inner layer 74 of the main body 64 and the first end 76 of the outer layer 72 of the main body 64, then weave the lower cuff 32. Another method of making this embodiment is: knit the outer layer 72 of the main body 64, then the outer layer 68 of the upper cuff 30, then the inner layer 70 of the upper cuff 30, then the inner layer 74 of the main body 64, then fold the inner layer 74 of main body 64 and inner layer 70 of the upper cuff 30 over the outer layer 72 of the main body 64 and outer layer 68 of the upper cuff 30, then sew over the first end 78 of inner layer 74 of the main body 64 and the first end 76 of the outer layer 72 of the main body 64, then weave the lower cuff. The reader will appreciate that the knitting process can be accomplished through any method that achieves the desired structure of this embodiment. Thus, the method should not be limited to these specific weaving processes.

FIGS. 12 and 13 illustrate several forces acting upon the two embodiments of the sock depicted in FIGS. 1 and 8 respectively. As illustrated in one embodiment, upper cuff 14 conforms to foreleg 22 of horse, creating a first force (shown by arrows labeled a) upon sock 10, assisting in holding sock 10 in the desired position on the horse's leg. While the arrows labeled (a) show an inward force as first force, the reader will appreciate that the force is a circumferential inward force (compressive force) acting all around the leg at upper cuff 14. Second section 56 of main body 16 conforms to cannon 62, creating a second force (shown by arrows labeled b) upon sock 10, also assisting in holding sock 10 in the desired position on the horse's leg (again this force is circumferential). The first force is greater than second force. Finally, lower cuff 18 conforms to pastern 42, creating a minimal third force (shown by arrows labeled c) upon sock 10, assisting in holding sock 10 in the desired position on the horse's leg, in this case, primarily assisting in positioning the sock 10 such that it will not slip over hoof 26 nor rise above fetlock joint 50 (again, the force is circumferential). The primary forces acting to hold sock 10 in the desired position on the leg of the horse are counteracted by secondary contrary forces. While gravity acts as a secondary force on the sock, its effect is minimal and therefore is greatly outweighed by the primary forces (a, b and c) discussed above which hold the sock in place. The secondary forces that are encountered are primarily from the movement of the horse, which in prior art socks acts to pull the sock in one direction or another, moving the sock out of the desired position or off of the leg entirely. The present design minimizes those secondary forces by creating a sock which allows for the movement of the sock around the relevant joints. As illustrated, third section 58 of main body 16 expands around knee joint 34. The motion of knee joint 34 creates a first contrary force (shown as arrows labeled x) acting to pull sock 10 out of its desired position. Further, the motion of fetlock joint 50 creates a second contrary force (shown as arrows labeled y) acting again to pull sock 10 out of its desired position. The first and second contrary force are minimized due to the expansion properties of sock 10 at first section 54 around fetlock joint 50 and third section 58 around knee joint 34. Thus, the sum of the forces holding the sock in its desired position is greater than the sum of the contrary forces acting to pull the sock out of its desired position thereby causing sock 10 to remain in position on the leg of the horse.

Similarly, the relevant forces acting upon sock 12 in the preferred embodiment shown in FIGS. 8 and 11 are discussed and further illustrated in FIG. 13. Upper cuff 30 conforms to cannon 62 of horse, creating a first amount of compressive force (shown by arrows labeled d—also shown in FIG. 11) on the leg of the horse, which is primarily responsible for holding sock 10 in the desired position on the leg of a horse. While the arrows labeled d, e and f show an inward force, the reader will appreciate that the force is a circumferential inward force (compressive force) acting all around the leg at upper cuff 30 and main body 64. A secondary contrary force (y) is created by the motion of fetlock joint 50. The sum total of any contrary forces caused by the movement of the leg is less than the first amount of compressive force (d), primarily acting to hold sock 12 in the desired position on the leg. Gravity acts as a secondary force on the sock, however its effect is minimal and therefore greatly outweighed by the primary forces (d, e and f) discussed above which hold the sock in place. The secondary forces that are encountered are primarily from the movement of the horse, which in prior art socks acts to pull the sock in one direction or another, moving the sock out of the desired position or off of the leg entirely. The present sock minimizes those secondary forces by creating a sock which allows for the movement of the sock around the relevant joints (reduction of compressive force around those joints—force e is less than d). Therefore, upper cuff 30 stays in position while main body 64 allows some give around the fetlock joint. As illustrated, main body 64 expands around fetlock joint 50 thereby reducing the secondary contrary force (y).

Additionally, as shown main body 64 provides a second and third amount of compressive force (shown by arrows labeled e and f) acting on the fetlock joint 50 and pastern 42, respectively. These compressive forces provide additional support to sock 12 while allowing for the reduction of the contrary force e (by reduction of compressive force e and f as compared to first compressive force d acting on upper cuff 30).

It is important to understand that there are two ways the compressive forces of the sock were tested. In Table 1, shown and described above, each section of the sock (upper cuff, main body at fetlock and main body at pastern) was measured based on uniform scaled expansion based on the diameter of each section of the sock in a relaxed state—thus, the sock and compressive pressure as the sock at each section is manufactured to maintain the unique functionality of the sock. These compressive forces are uniform and can be measured and described without the presence of an ungulate. However, additional testing was performed to illustrate the forces of the sock when applied to a standard sized horse (of different breeds). The following tables (Table 2, 3 and 4) illustrate these compressive forces. This testing and related tables will be described in turn.

Table 2, 3 and 4 shows the average compressive pressure as measured on three different sized “legs” of a horse (measurements taken from horses of the relevant breed for each respective table). It is important to recognize that the legs of each breed of horse do not vary greatly and the socks are designed and scaled with each breed of horse in mind. As the socks are stretched to a slightly wider horse of the same breed, the compressive force obviously increases as expansion increases. Each table is measured based on the embodiment of the sock shown in FIGS. 8-11 and 13-14. No measurements were taken for the alternate embodiment, nor is the alternate embodiment claimed.

Table 2 measures the different compressive forces caused by the sock acting on three different sport/pony horses. The first amount of compressive force acting on the leg proximate the cannon 62 falls between 16.8 mmHg and 20.8 mmHg. As shown in Table 3 (quarter/standard horse) the first amount of compressive force acting on the leg proximate the cannon 62 falls between 13.8 mmHg and 18.3 mmHg. Finally, as shown in Table 4 (warmblooded/thoroughbred horses) the first amount of compressive force acting on the leg proximate the cannon is 14.7 mmHg to 16.5 mmHg. Overall, it is desirable for the sock to exert a compressive pressure upon the average leg of a horse that is configured to be in the range from 10 mmHg to 25 mmHg (but most preferably in the range from 13 mmHg to 21 mmHg). The compressive force while applied to the leg of a horse (shown as arrows labeled d) is not so tight to make the animal uncomfortable but forceful enough to be secure upper cuff 30 around the cannon.

The second amount of compressive force (shown as arrows labeled e) measured at the fetlock joint and provided in Tables 2-4 is displayed in the same fashion as described above for the first amount of compressive force. The second amount of compressive force when on the leg of the average horse is configured to be in the range from 10 mmHg to 20 mmHg (but most preferably in the range from 13 mmHg to 18 mmHg). The third amount of compressive force (shown as arrows labeled f in FIG. 13) measured at the pastern and provided in Tables 2-4 is displayed in the same fashion as described above. The third amount of compressive force when on the leg of the average horse is configured to be in the range from 3 mmHg to 13 mmHg (but most preferably in the range from 4 mmHg to 10 mmHg).

Each table is shown as follows:

TABLE 2
Average Compressive Pressure Measured on Typical Legs of Sport/Pony Horse

| | | Average compressive | Average compressive | Average compressive |
|---|---|---|---|---|
| | Compressive pressure | pressure when the | pressure when the | pressure when the |
| | at relaxed state | sock is stretched to a | sock is stretched to a | sock is stretched to a |
| | (mmHg) | typical horse leg #1 | typical horse leg #2 | typical horse leg #3 |
| | (upper cuff = 16.5 cm, | (upper cuff = 18 cm, | (upper cuff = 20 cm, | (upper cuff = 22 cm; |
| | main body at fetlock | main body at fetlock | main body at fetlock | main body at fetlock |
| | joint = 18 cm, main | joint = 24 cm, main | joint = 26 cm, main | joint = 28 cm, main |
| | body at pastern = 18 cm) | body at pastern = 16 cm) | body at pastern = 18 cm) | body at pastern = 20 cm) |
| Upper cuff | 0 | 17.5 | 16.8 | 20.8 |
| Main body at | 0 | 13.2 | 14.4 | 15.3 |
| fetlock joint | | | | |
| Main body at | 0 | 6.5 | 7.3 | 9.9 |
| pastern | | | | |
| Lower cuff | 0 | N/A | N/A | N/A |

TABLE 3
Average Compressive Pressure Measured on Typical Legs of Quarter/Standard Horse

| | | Average compressive | Average compressive | Average compressive |
|---|---|---|---|---|
| | Compressive pressure | pressure when the | pressure when the | pressure when the |
| | at relaxed state | sock is stretched to a | sock is stretched to a | sock is stretched to a |
| | (mmHg) | typical horse leg #1 | typical horse leg #2 | typical horse leg #3 |
| | (upper cuff = 18 cm, | (upper cuff = 18 cm, | (upper cuff = 20 cm, | (upper cuff = 24 cm; |
| | main body at fetlock | main body at fetlock | main body at fetlock | main body at fetlock |
| | joint = 19 cm, main | joint = 24 cm, main | joint = 26 cm, main | joint = 29 cm, main |
| | body at pastern = 19 cm) | body at pastern = 16 cm) | body at pastern = 18 cm) | body at pastern = 22 cm) |
| Upper cuff | 0 | 13.8 | 15.1 | 18.3 |
| Main body at | 0 | 12.4 | 12.7 | 14.0 |
| fetlock joint | | | | |
| Main body at | 0 | 4.6 | 5.0 | 9.1 |
| pastern | | | | |
| Lower cuff | 0 | N/A | N/A | N/A |

TABLE 4
Average Compressive Pressure Measured on Typical Legs of
Warmblooded/Throughbred Horse

| | | Average compressive | Average compressive | Average compressive |
|---|---|---|---|---|
| | Compressive pressure | pressure when the | pressure when the | pressure when the |
| | at relaxed state | sock is stretched to a | sock is stretched to a | sock is stretched to a |
| | (mmHg) | typical horse leg #1 | typical horse leg #3 | typical horse leg #2 |
| | (upper cuff = 18 cm, | (upper cuff = 22 cm, | (upper cuff = 24 cm; | (upper cuff = 24 cm, |
| | main body at fetlock | main body at fetlock | main body at fetlock | main body at fetlock |
| | joint = 19 cm, main | joint = 28 cm, main | joint = 30 cm, main | joint = 32 cm, main |
| | body at pastern = 19 cm) | body at pastern = 20 cm) | body at pastern = 22 cm) | body at pastern = 24 cm) |
| Upper cuff | 0 | 14.7 | 15.8 | 16.5 |
| Main body at | 0 | 12.1 | 13.4 | 17.9 |
| fetlock joint | | | | |
| Main body at | 0 | 6.8 | 9.8 | 8.6 |
| pastern | | | | |
| Lower cuff | 0 | N/A | N/A | N/A |

The preceding description contains significant detail regarding the novel aspects of the present invention. It should not be construed, however, as limiting the scope of the invention but rather as providing illustrations of the preferred embodiments of the invention. As an example, upper cuff 30 and main body 64 can be knitted in the same manner, while still maintaining differing compressive forces, thereby effectively eliminating the appearance of an upper cuff 30. Additionally, main body 64 can include one or two expandable sections. Thus, the scope of the invention should be fixed by the following claims, rather than by the examples given.

1. A sock having a tubular shape for use on a leg of an ungulate, wherein said ungulate has a hoof, a knee joint, a fetlock joint and a pastern on said leg, wherein said sock has a relaxed state and an expanded state and maintains a position on said leg of said ungulate, comprising:
a. an upper cuff having a diameter in said relaxed state, a lower end and an upper end:
i. wherein said upper end of said upper cuff is configured to engage with said leg below said knee joint and further comprises an upper opening;
ii. wherein said lower end of said upper cuff is configured to engage with said leg above said fetlock joint;
iii. wherein said upper cuff is a compressive pressure construction providing a first amount of compressive pressure in said expanded state, and is configured to frictionally engage with said leg of said ungulate; and
b. a main body:
i. wherein said main body is connected to said lower end of said upper cuff;
ii. wherein said main body is hollow and has a first diameter in a relaxed state at a first point on said main body, and a second diameter in said relaxed state at a second point on said main body;
iii. wherein said main body at said first point provides a second amount of compressive pressure in said expanded state configured to engage with said leg proximate said fetlock joint;
iv. wherein said main body at said second point provides a third amount of compressive pressure in said expanded state configured to engage with said leg proximate said pastern;
v. wherein when said main body and said upper cuff are expanded in the same ratio, said second amount of compressive pressure is less than said first amount of compressive pressure
c. a lower cuff having a diameter in a relaxed state, an upper end and a lower end:
i. wherein said upper end of said lower cuff is connected to said main body;
ii. wherein said lower cuff is configured to expand at least two times said diameter in said relaxed state of said lower cuff;
iii. wherein said lower cuff provides negligible compressive pressure; and
iv. wherein said lower end of said lower cuff has a lower opening.

2. A sock as recited in claim 1, wherein said first amount of compressive pressure when said upper cuff is expanded to 1.5 times said relaxed state diameter is configured to be in the range of 13 mmHg to 24 mmHg.

3. A sock as recited in claim 1, wherein said first amount of compressive pressure when said upper cuff is expanded to 1.5 times said relaxed state diameter is configured to be in the range of 15 mmHg to 22 mmHg.

4. A sock as recited in claim 3, wherein said plurality of strands of yarn are selected from a group comprising:
a. polyester;
b. nylon;
c. elastic hydrocarbon polymer;
d. elastic polyurethane fabric; and
e. rubber.

5. A sock as recited in claim 3, wherein said plurality of strands of yarn contain fibers having antimicrobial properties.

6. A sock as recited in claim 2, wherein said wherein said second amount of compressive pressure when said main body at said first point is expanded to 1.5 times said relaxed state diameter is configured to be in the range of 10 mmHg to 17 mmHg.

7. A sock as recited in claim 3, wherein said second amount of compressive pressure when said main body at said first point is expanded to 1.5 times said relaxed state diameter is configured to be in the range of 12 mmHg to 15 mmHg.

8. A sock as recited in claim 1, wherein
a. said upper cuff has an inner layer and an outer layer;
b. said main body has an inner layer and an outer layer;
d. said inner layer of said main body has a first end and a second end;
e. said outer layer of said main body has a first end and a second end;
f. said inner body of said inner layer is connected to said layer of said lower cuff at the said first end while connected to said inner layer of said upper cuff at said second end;
g. said inner layer of said upper cuff is continuous with the said outer layer of said upper cuff;
h. said outer layer of said main body is connected to said layer of said lower cuff at the said first end while connected to said outer layer of said upper cuff at said second end; and
i. said first end of said outer layer of said main body is sewn to said first end of said inner layer of said main body.

9. A sock as recited in claim 8, wherein at least two ends of elastic hydrocarbon polymer are used in said inner and outer layer of said upper cuff and said inner and outer layer of said main body.

10. A sock as recited in claim 1, wherein only an elastic polyurethane fabric is used in said lower cuff.

11. A method of making a sock as recited in claim 8, comprising:
a. knitting said inner layer of said main body;
b. knitting said inner layer of said upper cuff;
c. knitting said outer layer of said upper cuff;
d. knitting said outer layer of said main body;
e. knitting said layer of said lower cuff; and
f. sewing said first end of said inner layer of said main body to said first end of said outer layer of said main body.

12. A method of making a sock as recited in claim 8, comprising:
a. knitting said outer layer of said main body;
b. knitting said outer layer of said upper cuff;
c. knitting said inner layer of said upper cuff;
d. knitting said inner layer of said main body;
e. knitting said layer of said lower cuff; and
f. sewing said first end of said inner layer of said main body to said first end of said outer layer of said main body.

13. A sock having a tubular shape for use on a leg of an ungulate, wherein said ungulate has a hoof, a hock joint, a fetlock joint and a pastern on said hind leg, wherein said sock has a relaxed state and an expanded state and maintains a position on said leg of said ungulate, comprising:
a. an upper cuff having a lower end, an upper end and a diameter in said relaxed state:
i. wherein said upper end of said upper cuff is configured to engage with said leg below said hock joint and further comprises an upper opening;
ii. wherein said lower end of said upper cuff is configured to engage with said leg above the said fetlock joint;
iii. wherein said upper cuff is a compressive pressure construction providing a first amount of compressive pressure in said expanded state and is configured to frictionally engage with said leg of said ungulate; and
b. a main body having a first point and second point:
i. wherein said main body is connected to said lower end of said upper cuff;
ii. wherein said main body is configured to engage with said fetlock joint at said first point and said pastern at said second point;
iii. wherein said main body is hollow and has a diameter at said first point and said second point in said relaxed state;
iv. wherein said main body is a compressive pressure construction providing a second amount of compressive pressure in said expanded state at said first point and a third amount of compressive pressure in said expanded state at said second point;
vi. wherein when said main body and said upper cuff are expanded in the same ratio, said said second and third amount of compressive pressure are less than said first compressive pressure of said upper cuff; and
c. a lower cuff having a diameter in said relaxed state, an upper end and a lower end:
i. wherein said upper end of said lower cuff is connected to said main body; and
iii. wherein said lower end of said lower cuff has a lower opening.

14. A sock as recited in claim 13, wherein said first amount of compressive pressure when said upper cuff is expanded to 1.5 times said relaxed state diameter is configured to be in the range of from 13 mmHg to 24 mmHg.

15. A sock as recited in claim 13, wherein said first amount of compressive pressure when said upper cuff is expanded to 1.5 times said relaxed state diameter is configured to be in the range of from 15 mmHg to 22 mmHg.

16. A sock as recited in claim 14, wherein said plurality of strands of yarn are selected from a group comprising:
a. polyester;
b. nylon;
c. elastic hydrocarbon polymer;
d. elastic polyurethane fabric; and
e. rubber.

17. (canceled)

18. (canceled)

19. (canceled)

20. (canceled)

21. A sock as recited in claim 1, wherein said upper cuff is configured to expand at least two times said diameter in said relaxed state of said upper cuff.

22. A sock as recited in claim 13, wherein said second and third amount of compressive pressure when said main body at said first point and said second point are expanded to 1.5 times said relaxed state diameter is configured to be in the range of 9 mmHg to 17 mmHg.

23. A sock as recited in claim 13, wherein said second and third amount of compressive pressure when said main body at said first and said second point are expanded to 1.5 times said relaxed state diameter is configured to be in the range of 11 mmHg to 15 mmHg.

24. A sock as recited in claim 13, wherein said lower cuff provides negligible compressive pressure.
